(19) United States
(12) Patent Application Publication
(10) Pub. No.: US 2007/0231438 A1
(43) Pub. Date: Oct. 4, 2007

(54) Antioxidant and Its Use

(75) Inventor: Harri Repo, Lahti (FI)

Correspondence Address: VENABLE LLP, P.O. BOX 34385, WASHINGTON, DC, 20043-9998, US

(73) Assignee: Oy Vegaoils Ltd., Hollola (FI)

(21) Appl. No.: 10/569,094

(22) PCT Filed: Aug. 20, 2004
(86) PCT No.: PCT/FI04/00493

§ 371 Date: Mar. 22, 2007

(30) Foreign Application Priority Data
Aug. 22, 2003 (FI) 20031190

(51) Int. Cl. A23D 9/007; C09K 15/06

(52) U.S. Cl. 426/541; 252/407; 426/417

(57) ABSTRACT

An antioxidant containing ascorbic acid dissolved into a liquid carrier substance of a short-chained alcohol. The antioxidant is fat-soluble and is applicable to be added to food fat or oil in order to delay or prevent the development of rancidity in the preparation.

The invention relates to an antioxidant, a food oil preparation or fat preparation, which contains antioxidant, as well as the use of an antioxidant. In addition to food fats and food oils, the invention also relates to a technical oil or grease, which contains antioxidant. The invention relates especially to such oil preparations and fat preparations, which are required to have long preservability at room temperature or even at a temperature of 30 to 40° C., for example, due to transportation and storage taking place without refrigeration in a warm climate.

Several vegetable fats are known that are in the form of oil (vegetable oils), such as turnip rapeseed or rapeseed oil, corn oil, sunflower oil, soybean oil and olive oil. Vegetable oil can also be a mixture of oils from different vegetables. Fats in a solid form include, for example, lard. Fats and oils can be animal-based or vegetable-based.

A problem of all the oils and fats used with food products is that they become rancid, which also spoils the food product containing the preparation. Rancidity affects especially the odour and taste of the preparation and the finished food product and thus directly consumer satisfaction. This problem occurs, for example, when preserving an oil preparation or fat preparation for long periods of time. Rancidity is, in addition, faster if the preparation is stored or transported at room temperature, or at temperatures higher than that because of climatic factors or a missing cold chain. For example, it is customary to transport vegetable oils even long distances in large containers at the temperature of the environment, without refrigeration. Rancidity prevention has traditionally been aimed to be improved by means of antioxidants added to the preparation.

Rancidity in fat or oil is a complex process, which produces reactive units, such as organic peroxides, alcohols, aldehydes, ketone compounds, and carboxylic acids. Of the many possible oxidation reactions, the most common is the formation of free radicals in the fatty acids containing a double bond, which are otherwise recommended in a diet. These free radicals bind oxygen and form a peroxide radical, which enables a chain reaction and produces organic peroxides as a main product. These peroxides transform into secondary products, such as alcohol and carbonyl compounds, which further oxidize into carboxylic acids. At the same time the tocopherols possibly contained in the vegetable oil lose their antioxidant properties. Rancidity can take place in connection with the transportation, storage or use of fat or oil and also when the oil or fat is in a finished food product. Thus, the quality of the food fat or oil has a crucial effect on the quality of the food product manufactured by means of it, such as pastries.

The existing known product solutions use propyl gallate, butyl hydroxy anisole (BHA), butyl hydroxy toluene (BHT), or ascorbic acid as antioxidants.

Synthetic antioxidants, such as butyl hydroxy anisole (BHA) and butyl hydroxy toluene (BHT), may cause unwanted side effects if their recommended daily dosage is exceeded. Indeed, this has caused an ever-growing interest in natural antioxidants.

Ascorbic acid is a known and safe natural antioxidant, the use of which is problematic mainly because of its bad thermal resistance, and in view of fat and oil use, its water-solubility as well. Ascorbic acid tends to crystallize in oil and thus loses its effectiveness.

Fat-soluble ascorbic acid derivatives, such as ascorbyl palmitate, have been developed for oils and fats. Different ascorbic acid derivatives are disclosed in the article “Vitamin C derivatives as antioxidant agents”. Ascorbyl palmitate also has a limited solubility in oil (250 ppm) and even in the best cases together with tocopherols it has been reported to have approximately 2.5-fold protective factors in vegetable oils (rancidity time obtained with addition/rancidity time of the control sample).

The U.S. Pat. No. 5,084,293 (Paul H. Todd) discloses the activation of ascorbic acid by means of several recipes by using non-ionic emulgators, such as glyceryl monooleate (GMO), together with in the antioxidant composition is only 2 wt-%, and the product is not sensible technically and economically.

The purpose of the invention is to eliminate problems related to the preservability of a food oil preparation and a food fat preparation and a food product manufactured by means of it, and to provide a composition containing ascorbic acid, as well as a food oil or food fat product, which remains non-rancid considerably longer than the present preparations. The invention is based on a natural water-soluble antioxidant, ascorbic acid.

Ascorbic acid here refers to an antioxidant whose structure corresponds to the natural substance, but which is generally synthetically manufactured.

The invention is applicable to vegetable or animal based oils and fats that contain non-saturated fats (triglycerides) or other easily rancid substances, and that can be used in the manufacture of food products as the part remaining in the food product. One application area is also technical greases and oils.

In order to achieve the purpose of the invention the antioxidant according to the invention is primarily characterized in that it comprises ascorbic acid dissolved in a carrier substance of alcohol, which, being fat soluble, can distribute the ascorbic acid homogenously to fat or oil. The composition in question is a “concentrate” that can be dosed into the bulk mass of oil or fat. The amount of the concentrate is calculated according to the desired end concentration of the antioxidant. There is advantageously at least 15 wt-% of ascorbic acid in the composition, preferably 15 to 30 wt-%. The composition may contain other active ingredients dissolved in the carrier substance, such as tocopherols. It is possible to dissolve several oil or fat additives in the carrier substance in the ratio they are desired to be included in the preparation.

This concentrate is a preparation that is liquid in room temperature and mixes well into flowing fats (e.g. vegetable oils). It can, however, also be used as a part of such fats that are solid in room temperature. The carrier substance must be anhydrous, because even minimal water concentrations weaken the effectiveness of ascorbic acid.

According to an especially advantageous embodiment, the short-chained alcohol is propylene glycol, which is accepted as a carrier substance used in food product in EU and which has the E-code E1520. Propylene glycol is liquid at room temperature and a safe carrier substance, which can remain in food fat or oil, and it does not need to be removed in a separate process stage. Similarly, it is easy to make absolutely anhydrous, for example, by heating. Similarly, it is possible to make relatively large amounts of ascorbic acid to dissolve in it when it functions as single carrier substance, i.e. no other carrier substances or auxiliary agents are needed.

According to an advantageous embodiment there is also citric acid (E330) in the carrier substance, which increases especially the physical stability of ascorbic acid. The citric acid also functions as a binder of metal ions in the case that oil or fat is transported or stored in a metal container. In view of food product use, there is, for example, 1 to 10 wt-% of citric acid, advantageously 3 to 10 wt-%, preferably approximately 5 wt-%, and in a composition intended for technical oils and greases even 10 to 25 wt-%. There is advantageously less citric acid than ascorbic acid, while the ratio of the amounts of citric acid and ascorbic acid is advantageously 1:6 at the most, unless in a case of preparations intended for technical oils or greases or deep-frying oil. In preparations for these purposes that ratio is greater, but even in them there is advantageously less citric acid than ascorbic acid.

A composition where the antioxidant is dissolved in a carrier substance is added to the actual oil or fat in an amount that corresponds to the desired concentration of ascorbic acid in the oil or fat preparation. The ascorbic acid dissolves completely in oil or fat thanks to the alcohol, which distributes the ascorbic acid to molecular level throughout oil or fat without the ascorbic acid crystallizing. In this manner it is possible to manufacture fat-soluble ascorbic acid without chemical derivatives. One advantage is also the decreased costs of antioxidant per oil or fat ton based on the low price of ascorbic acid in comparison to fat-soluble ascorbic acid derivatives.

Ascorbic acid has great thermal resistance when it is dissolved in fat or oil phase. When it moves over to water phase, it has normal physiological properties, in addition to the antioxidant properties. If in connection with the downstream operation of a food product, for example, when mixing oil or fat to other components, water is included, the ascorbic acid can operate favourably also in the water phase.

In the following, the invention will be described more in detail by means of some examples, which do not restrict the invention.

The antioxidant (concentrate) added to different vegetable oils had the following composition:

1) ascorbic acid 20 wt-%, propane-1,2-diol 80 wt-%

2) ascorbic acid 20 wt-%, citric acid 5 wt-%, tocopherols 1 wt-%, the remainder propane-1,2-diol

3) ascorbic acid 30 wt-%, citric acid 1 wt-%, the remainder propane-1,2-diol.

Testing the oil samples was performed with the Rancimat 743 device, which is manufactured by Metrohm Ltd., Switzerland. The method used is generally called the “Rancimat method” (Laubli, M. W. and Bruttel, P. A. Determination of the oxidative stability of fats and oils; comparison between the active oxygen method (AOCS Cd 12-57) and the rancimat method. J. Am. Oil Chem. Soc. 63: 792-795 (1986)).

In the test, 6 grams of the samples were weighed to the reaction vessel, and the samples were heated to 120° C. A continuous airflow at a rate of 20 l/h was passed to the samples. Electroconductivity was measured from the test vessels, into which had been dosed 60 mL of distilled water.

### EXAMPLES 1 TO 9

Ascorbic acid was dissolved in the carrier in approx. 97 degrees by mixing, and the thus resulting antioxidant compositions were added to different oils.

In the following, reference is made to the figures, which have the same number as the number of the example.

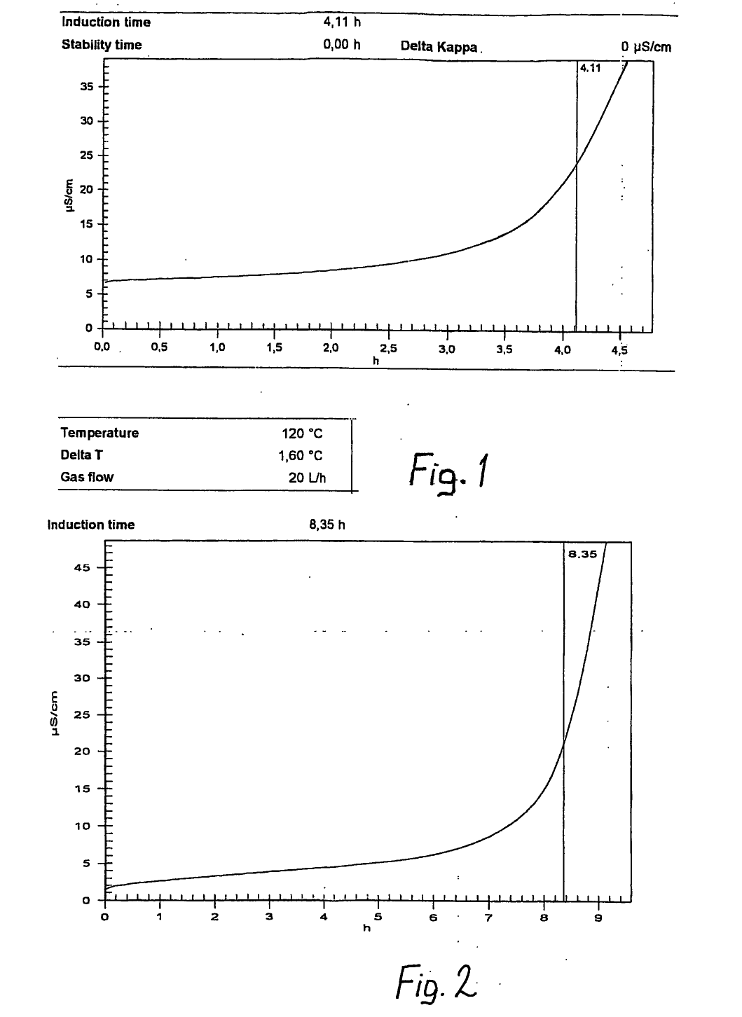

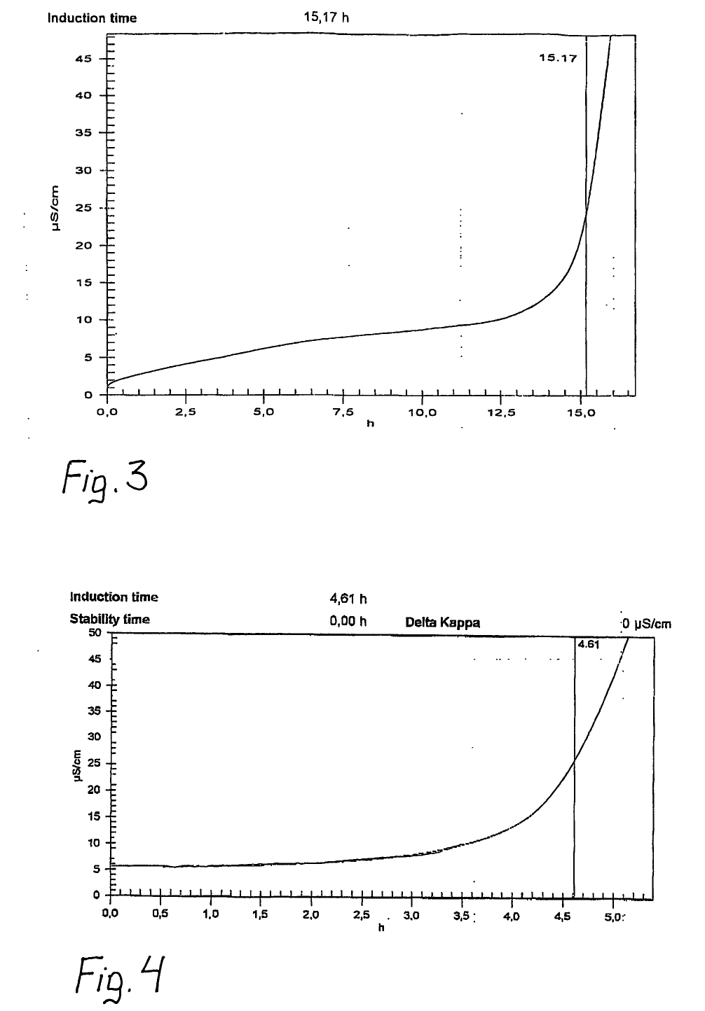

FIG. 1 presents a comparison test performed without addition, corn oil as the oil (Holland). Induction time was 4.11 h.

FIG. 2 presents the result received with the oil of FIG. 1 when 0.2 wt-% of antioxidant 1 was added, which corresponds to the ascorbic acid concentration of 0.04 wt-%. Induction time was 8.35 h, i.e. the protective factor (8.35/4.11) was already over 2.

FIG. 3 presents the result received with the oil of FIG. 1 when 0.4 wt-% of antioxidant 1 was added, which corresponds to the ascorbic acid concentration of 0.08 wt-%. The induction time was 15.17 h, i.e. the protective factor (15.17/4.11) was over 3.5, more than has been reported for fat-soluble ascorbic acid derivatives.

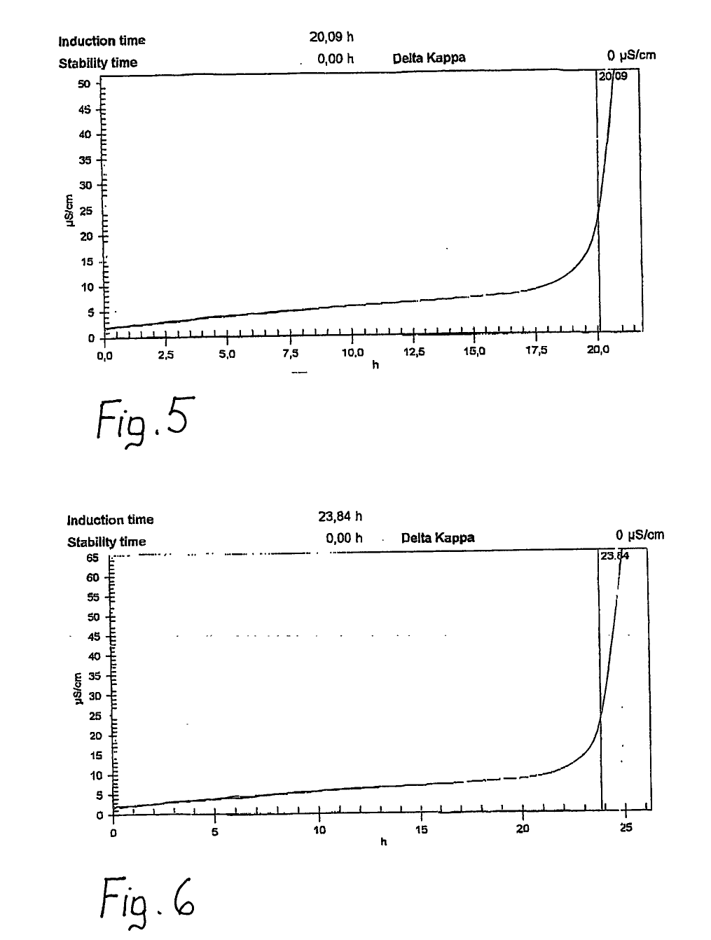

FIG. 4 presents a comparison test performed with Olitalia corn oil without addition, where the induction time was 4.61 h.

FIG. 5 presents the result received with the oil of FIG. 4 when 0.4 wt-% of antioxidant 1 was added, which corresponds to the ascorbic acid concentration of 0.08 wt-%. Induction time was 20.09 h, i.e. the protective factor was clearly over 4.

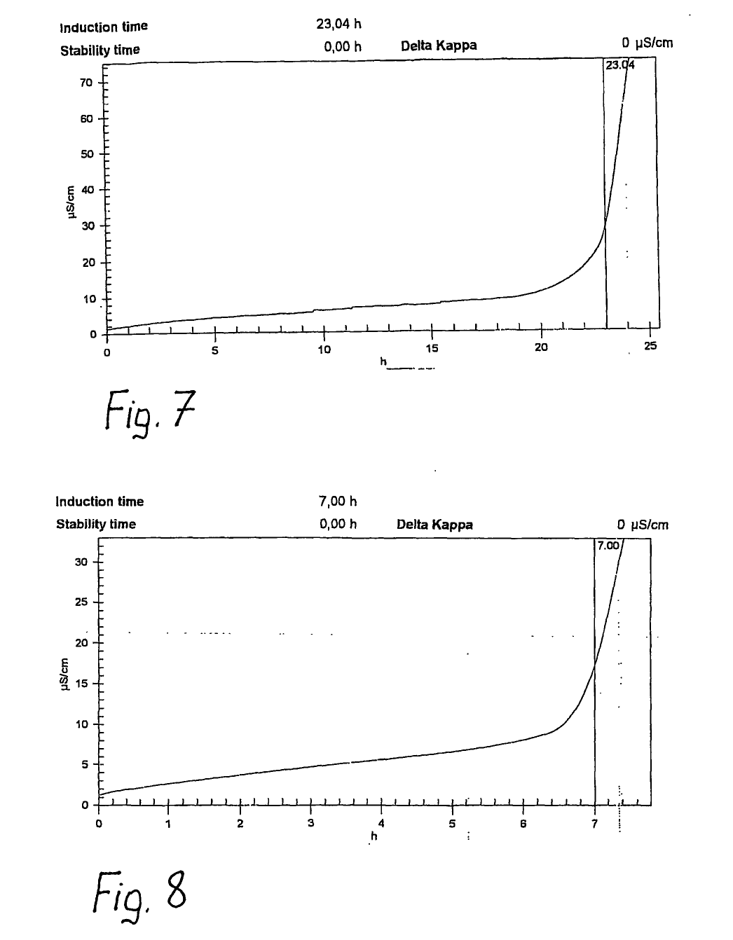

FIG. 6 presents the result received with the oil of FIG. 4 when 0.4 wt-% of antioxidant 2 (included citric acid and tocopherol as well) was added, which corresponds to the ascorbic acid concentration of 0.08 wt-%. Induction time was 23.84 h, i.e. the protective factor was over 5.

FIG. 7 presents the result received with turnip rapeseed oil (beginning level approx. 2 h) when 0.4 wt-% of antioxidant 1 was added, which corresponds to the ascorbic acid concentration of 0.08 wt-%. Induction time was 23.04 h, i.e. the protective factor was, even when estimated carefully, approx. 10

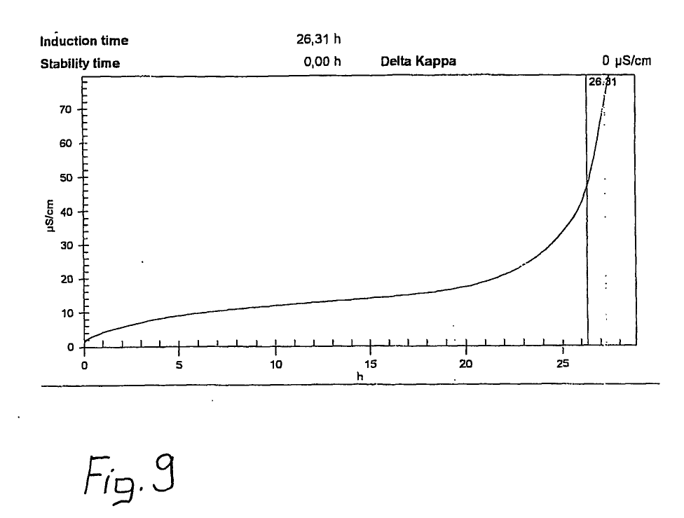

FIG. 8 contains the same test with sunflower oil, whose starting level was 2.2 to 2.4 h. The result 7.0 h corresponds to the protective factor of approx. 3.

FIG. 9 illustrates how with an addition of 0.4 wt-% (0.08 wt-% of ascorbic acid) it is possible to increase induction time in oil, where the induction time has already been increased with an antioxidant addition, in this case with a mixture of synthetic tocopherols. Lecithin and citric acid had also been added to the oil. In this case, from the starting level of 12 h, yet a double induction time of 26.31 was reached.

### EXAMPLES 10 TO 23

The antioxidants were manufactured with different processing methods and mixtures and then added to turnip rapeseed oil. The finished oils were analyzed with the Rancimat method.

Basic oil, turnip rapeseed oil, gave an induction time of 4.46 h.

In examples 15 and 16, antioxidant 2 (without tocopherol) was added when the dissolving temperatures of ascorbic acid into propylene glycol were 97 and 110 degrees, respectively. The end concentration of ascorbic acid/citric acid in turnip rapeseed oil was 800 ppm/200 ppm. The induction times were 11.62 h and 12.52 h, respectively, protective factors 2.6 and 2.8.

In example 17 (comparison example), with a known antioxidant mixture (E306, tocopherol) and with the end concentration of antioxidants of 1000 ppm, the induction time was 4.67, and the protective factor approx. 1.05.

In example 18 (comparison example) the second known antioxidant mixture (BHA+propyl gallate+citric acid; E320+E316+E330) with the end concentration of antioxidants of 1000 ppm, the induction time was 7.13 and the protective factor approx. 1.6.

In example 19, with the antioxidant according to example 15, when an antioxidant mixture according to example 17 was also contained in the turnip rapeseed oil, while the end concentrations in oil were the same as in the above-mentioned examples, the induction time was 11.92 h and the protective factor 2.7.

In example 20, with the antioxidant according to example 15, when an antioxidant mixture according to example 18 was also contained in the turnip rapeseed oil, while the end concentrations in oil were the same as in the above-mentioned examples, the induction time was 13.58 h and the protective factor 3.0.

In example 21 antioxidant 3 was used. Ascorbic acid was dissolved in propylene glycol at 110 degrees. Antioxidant 3 was added to oil in such a manner that the end concentration of ascorbic acid/citric acid in oil was 800 ppm/26.7 ppm. The induction time was 23.46 h and the protective factor approx. 5.3.

In example 22 the oil contained antioxidant according to example 21 and antioxidant mixture according to example 17, the end concentrations in oil were the same as in the examples in question. Induction time 21.29 h, protective factor approx. 4.8.

In example 23 a half less of the antioxidant according to example 21 was added (ascorbic acid/citric acid 400 ppm/13.4 ppm in turnip rapeseed oil). Induction time 13.39 h, protective factor approx. 3.0.

The above-presented tests prove that the rancidity tendency of vegetable oils containing non-saturated fats (triglycerides) can be significantly decreased with an antioxidant that is natural, has known physiological effects, and is inexpensive.

In addition if the vegetable oil contains natural (vegetable-based) tocopherols or added natural tocopherols, the ascorbic acid functions as their regenerator. Natural tocopherol refers to tocopherols, which have antioxidant effects in the living body. Natural tocopherols, e.g. d-alpha-tocopherol, can be added to the same carrier substance where the ascorbic acid has been dissolved. Depending on the oil, it is advantageous to add natural d-alpha-tocopherol in such a manner that the alpha-tocopherol amount 500 ppm in oil is not exceeded. It is also possible to add synthetic tocopherols in the carrier substance. Generally, the carrier substance of ascorbic acid can be used in order to add other desired active ingredients, e.g. emulgators and/or aroma agents, into oil or fat, in which case the antioxidant composition or concentrate forms a ready-to-use additive packet.

The added tocopherol mixture typically contains 5 to 10 wt-% of alpha-tocopherol, 40 to 65 wt-% of gamma-tocopherol and 25 to 55 wt-% of delta-tocopherol. This type of a tocopherol mixture is added advantageously so much that the total tocopherol of the preparation (including the tocopherol inherent in the oil) is at least 0.02 wt-%.

The added synthetic tocopherol is sensitive and acts as a fast antioxidant. It is advantageous that the added synthetic tocopherol is a mixture of at least gamma and delta-tocopherol.

Citric acid normally has a weakening action on the antioxidant effect. Its addition is, however, well-grounded, if food oil comes into contact with metal surfaces during the manufacturing process of a food product (ion catcher). When oil comes into contact with metal surfaces in a high temperature and the same oil is used repeatedly, such as deep-frying oil, more of it can be used, but even then its amount is advantageously a third of the amount of ascorbic acid at the most (for example 5 wt-%/20 wt-%, i.e. approx. one fourth). For domestic use as a normal cooking oil, its amount can be even smaller ( 1/10 at the most). For example, the composition added to deep-frying oil can contain 20 wt-% of ascorbic acid and 5 wt-% of citric acid. In a preparation added to oil intended for normal domestic food product use the amount of substances can be 30 wt-% and 1 wt-%, respectively.

Other substances that may come into question in the composition include lecithin.

The following combinations are possible in the same carrier substance, advantageously in propylene glycol:
Ascorbic acid+tocopherol(s)
Ascorbic acid+lecithin
Ascorbic acid+tocopherol(s)+lecithin
In all of the above, possibly citric acid as synergist

The invention is applicable to all oils and fats, where there are compounds that easily cause rancidity. The invention is also applicable to such oils where there are other substances causing rancidity than triglycerides containing double-bond fatty acids, such as, for example, butter aroma, which is added to vegetable oil to provide a liquid food oil resembling butter by its flavour.

Propylene glycol is not the only carrier substance that can come into question. It is also possible to use other short-chained liquid alcohol carrier substances suitable for food products, to which ascorbic acid can be dissolved and which distribute ascorbic acid throughout the substance on molecular level when dissolving into oil or fat. In the case of fats solid at room temperature, the fat is melted into such form, by means of which alcohol and ascorbic acid along with the alcohol can be divided homogeneously into the high flash point (over 180 degrees) of propylene glycol is advantageous in all processing where heat is used.

Another possible carrier substance is ethanol. The volatility of ethanol, however, causes problems, which may be avoided by dissolving the ethanol and ascorbic acid first to oil, for example, after which in the heat processing (which may be connected to the normal raffination process of oil) the ethanol is evaporated, in which case there is no danger that volatile ethanol remains in the preparation, which during transportation and storage would provide the product an undesired odour. Ethanol can also be added to hot oil. This is also an example of how the carrier substance does not necessarily have to remain in the oil or fat. A problem of ethanol in comparison to propylene glycol is that it is difficult to make absolutely anhydrous by means that are simple and safe from the point of food product use.

Even though above the invention is referred to in connection with test examples of some vegetable oils generally used in the food industry and which are liquid in room temperature, the invention is also applicable to other vegetable oils, all of which do not need to be in food use, such as soybean oil, olive oil, palm oil, peanut oil, castor oil and linseed oil. The invention is also applicable to solid food fats, and in addition to food fats and oils also to technical greases and oils, such as lubricating oils and hydraulic oils. In the case of these it is not necessary to take into account the food compatibility of the carrier substance, but an alcohol carrier most suitable from the point of view of the process is used, e.g. glycol or butanol. The antioxidant used in these applications also comprises citric acid dissolved in alcohol, which is advantageous if the oil comes into contact with metals during the process (e.g. machining or lubricating).

One area of use for the invention is also the fatty acid esters of vegetable oils, such as RME, substances used as bio-diesels, the preservability of which may be a problem. The oil portion of the vegetable oil does not, therefore, necessarily need to be native, but it can also be modified.

In all technical applications the advantage is that the rancidity affecting the technical properties of oil/fat can also be significantly decelerated.

The antioxidant is manufactured most suitably in such a manner that the carrier substance, for example propylene glycol, is heated close to 100 degrees, after which the ascorbic acid and other active ingredients are added. If citric acid is used, it is added advantageously before the ascorbic acid. The best order of addition is citric acid, ascorbic acid right after it, and last the other possible active ingredients, such as, for example, tocopherols. After the addition of substances, the mixture is homogenized. With homogenization it is possible to improve the long-term preservability (prevention of re-crystallization) of the antioxidant (ascorbic acid+carrier).

When using propylene glycol, it is pre-heated preferably over 100 degrees in order to ensure the removal of water (absolutely anhydrous carrier). After this, ascorbic acid is added. Since ascorbic acid is at room temperature and its amount is relatively large, it at the same time cools down the carrier below 100 degrees. After the dissolution, the homogenization is started as quickly as possible, and the temperature is at the same time adjusted close to 100 degrees, but below it, advantageously between 97 to 98. If citric acid is used, it is added preferably first to the pre-heated propylene glycol before the ascorbic acid.

30 wt-% of ascorbic acid can also be added to anhydrous propylene glycol and heated at a temperature of over 100 degrees for a short time, for example, 110° C./5 min, after which the mixture is homogenized.

The antioxidant mixture is homogenized when hot as quickly as possible after the dissolution of ascorbic acid in high pressure, for example, over 100 bar, advantageously approx. 150 bar.

In order for the effect of the ascorbic acid to be best used when the antioxidant according to the invention is added to oil, the composition (carrier substance, ascorbic acid and possibly other dissolved substances) are added to fresh and preferably hot oil by injecting and airless homogenization. The temperature in this mixing phase to oil is advantageously 80 to 110° C. and the pressure approx. 100 bar in homogenization. For example, in the case of vegetable oils, it is advisable to add the antioxidant relatively quickly after the oil is separated from the vegetable material (for example immediately after pressing and other further processing phases).

It is advantageous that there is as much of ascorbic acid dissolved in the carrier as possible. When the concentration of ascorbic acid in the propylene glycol is at least 15 wt-%, e.g. 15 to 30 wt-%, in order to reach ascorbic acid concentration of 800 ppm, for example, it is necessary to add the antioxidant composition 0.533 wt-% at the most, e.g. only 0.267 to 0.533 wt-%, which corresponds to the propylene glycol concentration of 0.187 to 0.453 wt-% in food oil or fat. If the target concentration is 400 ppm, the corresponding numbers are 0.093 to 0.227 wt-% for propylene glycol. For example, directive 95/2/EC on food additives other than colours and sweeteners, published 29 Jan. 2004, gives 0.3% of the food product as the new use limit of propylene glycol E 1520. For an antioxidant, where there is 15 to 30 wt-% of ascorbic acid, this would mean approximately 530 to 1280 ppm ascorbic acid concentrations in a food product.

1-19. (canceled)

20. An antioxidant that is based on ascorbic acid, said antioxidant comprising:
ascorbic acid dissolved into a carrier substance of an alcohol, which can distribute homogeneously in fat.

21. The antioxidant according to claim 20, wherein the alcohol is propylene glycol or ethanol.

22. The antioxidant according to claim 21, further comprising:
citric acid dissolved in the carrier substance.

23. The antioxidant according to claim 22, wherein there is more ascorbic acid than citric acid.

24. The antioxidant according to claim 21, further comprising:
one or more tocopherols dissolved in the carrier substance.

25. The antioxidant according to claim 21, wherein the amount of ascorbic acid is at least 15 wt-%.

26. The antioxidant according to claim 25, wherein the amount of ascorbic acid is 15 to 30 wt-%.

27. The antioxidant according to claim 24, wherein the amount of ascorbic acid is at least 15 wt-%.

28. The antioxidant according to claim 27, wherein the amount of ascorbic acid is 15 to 30 wt-%.

29. The antioxidant according to claim 25, wherein the amount of citric acid is 1 to 25 wt-%.

30. The antioxidant according to claim 29, wherein the amount of citric acid is 3 to 25 wt-%.

31. The antioxidant according to claim 26, wherein the amount of citric acid is 1 to 25 wt-%.

32. The antioxidant according to claim 31, wherein the amount of citric acid is 3 to 25 wt-%.

33. The antioxidant according to claim 27, wherein the amount of citric acid is 1 to 25 wt-%.

34. The antioxidant according to claim 28, wherein the amount of citric acid is 1 to 25 wt-%.

35. The antioxidant according to claim 25, wherein the carrier substance is anhydrous propylene glycol.

36. The antioxidant according to claim 35, wherein the anhydrous propylene glycol is a single carrier substance.

37. The antioxidant according to claim 26, wherein the carrier substance is anhydrous propylene glycol.

38. The antioxidant according to claim 37, wherein the anhydrous propylene glycol is a single carrier substance.

39. The antioxidant according to claim 31, wherein the carrier substance is anhydrous propylene glycol.

40. The antioxidant according to claim 39, wherein the anhydrous propylene glycol is a single carrier substance.

41. The antioxidant according to claim 25, wherein the ascorbic acid is mixed by homogenization into propylene glycol carrier.

42. The antioxidant according to claim 26, wherein the ascorbic acid is mixed by homogenization into propylene glycol carrier.

43. The antioxidant according to claim 31, wherein the ascorbic acid is mixed by homogenization into propylene glycol carrier.

44. The antioxidant according to claim 35, wherein the ascorbic acid is mixed by homogenization into the anhydrous propylene glycol carrier.

45. The antioxidant according to claim 37, wherein the ascorbic acid is mixed by homogenization into the anhydrous propylene glycol carrier.

46. The antioxidant according to claim 39, wherein the ascorbic acid is mixed by homogenization into the anhydrous propylene glycol carrier.

47. The use of an antioxidant in fat or oil as an additive preventing or delaying the development of its rancidity, wherein the antioxidant has the composition according to claim 25.

48. The use according to claim 28, wherein the amount of ascorbic acid is 15 to 30 wt-% in the antioxidant.

49. The use according to claim 48, wherein the amount of citric acid is 1 to 25 wt-% in the antioxidant.

50. The use of an antioxidant in food fat or oil as an additive preventing or delaying the development of its rancidity, wherein the antioxidant has the composition according to claim 6.

51. The use according to claim 50, wherein the amount of ascorbic acid is 15 to 30 wt-% in the antioxidant.

52. The use according to claim 51, wherein the amount of citric acid is 1 to 25 wt-% in the antioxidant.

53. A food fat or food oil preparation, comprising:
fat or oil; and
antioxidant added to the fat or oil, wherein the antioxidant comprises fat-soluble ascorbic acid.

54. The preparation according to claim 53, wherein there is 0.02 to 0.2 wt-% of ascorbic acid of the weight of the preparation.

55. The preparation according to claim 54, wherein there is 0.05 to 0.1 wt-% of ascorbic acid.

56. The preparation according to claim 54, wherein the concentration of ascorbic acid in the preparation is 400 to 800 ppm (0.04 to 0.08 wt-%).

57. The preparation according to claim 54, wherein the oil is vegetable oil.

58. The preparation according to claim 55, wherein the oil is vegetable oil.

59. The preparation according to claim 57, wherein the vegetable oil is corn oil, sunflower oil, olive oil, turnip rapeseed or rapeseed oil, soybean oil, palm oil, peanut oil, castor oil, linseed oil or a mixture of them.

60. The preparation according to claim 58, wherein the vegetable oil is corn oil, sunflower oil, olive oil, turnip rapeseed or rapeseed oil, soybean oil, palm oil, peanut oil, castor oil, linseed oil or a mixture of them.

61. The preparation according to claim 54, wherein the antioxidant composition comprises:
ascorbic acid in an amount of 15 to 30 wt-% dissolved in a carrier substance of propylene glycol or ethanol, said carrier substance being distributed homogeneously in the fat or oil phase of the preparation,
said preparation having, when compared to the preparation before the addition, a protective factor of over 3 times when calculated with the formula t(2)/(t1), where t(1) is the induction time obtained by means of the Rancimat method before the antioxidant addition and t(2) is the induction time obtained for the same preparation after the antioxidant addition by means of the Rancimat method.

62. The preparation according to claim 54, wherein the antioxidant composition comprises:
ascorbic acid in an amount of 15 to 30 wt-% dissolved in a carrier substance of propylene glycol or ethanol, said carrier substance being distributed homogeneously in the fat or oil phase of the preparation,
the induction time of said preparation obtained by means of the Rancimat method being over 12 h.

63. The preparation according to claim 62, wherein the induction time is over 20 h.

64. The preparation according to claim 54, wherein the antioxidant composition comprises:
ascorbic acid in an amount of 15 to 30 wt-% dissolved in a carrier substance of propylene glycol or ethanol, said carrier substance being distributed homogeneously in the fat or oil phase of the preparation,
wherein the antioxidant composition has been added to the preparation by homogenization.

65. The preparation according to claim 63, wherein the antioxidant composition comprises:
ascorbic acid in an amount of 15 to 30 wt-% dissolved in a carrier substance of propylene glycol or ethanol, said carrier substance being distributed homogeneously in the fat or oil phase of the preparation,
wherein the antioxidant composition has been added to the preparation by homogenization.

66. A method of preventing or delaying the development of rancidity in food fat or oil, the method comprising:
dissolving an antioxidant composition comprising ascorbic acid in an amount of 15 to 30 wt-% in a carrier substance of propylene glycol or ethanol;
adding the antioxidant composition to the food fat or oil; and
homogeneously distributing said carrier substance in the food fat or oil.

67. The method according to claim 66, wherein the antioxidant composition comprises citric acid in an amount of 1 to 25 wt-%.

68. The method according to claim 66, wherein the food oil is vegetable oil selected from the group consisting of corn oil, sunflower oil, olive oil, turnip rapeseed oil, rapeseed oil, soybean oil, palm oil, peanut oil, castor oil, linseed oil and any mixture of them.
